(19) United States
(12) Patent Application Publication
(10) Pub. No.: US 2010/0143072 A1
(43) Pub. Date: Jun. 10, 2010

(54) Fastener and Driving Tool

(76) Inventor: Cheong Kong Chang, Kuala Lumpur (MY)

Correspondence Address: VEDDER PRICE P.C., 222 N. LASALLE STREET, CHICAGO, IL, 60601, US

(21) Appl. No.: 12/600,186

(22) PCT Filed: May 9, 2008
(86) PCT No.: PCT/MY08/00037

§ 371 Date: Nov. 13, 2009

(30) Foreign Application Priority Data
May 15, 2007 (MY) 20070754

(51) Int. Cl. F16B 23/00; B25B 23/00

(52) U.S. Cl. 411/407; 81/460

(57) ABSTRACT

An improved fastener (10) comprises of a threaded shank (11), and a head (12) having a tool engaging recess (13) formed by a plurality of grooves (16) comprising an inner portion located approximately within circumference of shank (11), formed by inclined side walls (28, 31, 32) of part elliptical configurations disposed convexly and symmetrically to central axis and bisector lines; an outer portion formed with pairs of inclined flat drive walls (16a) extending to concentric peripheral arcs (16b) near circumference of head (12) to maximize torque transfer and sharp drive corners (30); sharp interlocking corners (17) separate inner portion from outer portion of the grooves enabling an interlocking action during the turning of the fastener and thus preventing the bit from slipping out even during high resistance to penetration of the fastener; and base walls (19) with an inner portion (22) and an outer portion (21); wherein the grooves extend in radial direction from a central axis (15) and symmetrically spaced at bisector lines (18) of grooves (16) on top of head (12). The driving tool includes a shank and a drive head with respective drive bits that engage in and substantially conform to the shape of the recess of the fastener for a snug fit for efficient torque transfer.

### FIELD OF INVENTION

The present invention generally relates to threaded fasteners and its related fastening tool, more particularly to a threaded fastener having a non-standard form of driving recess and a fastening tool for engagement within such recess.

### BACKGROUND OF THE INVENTION

Fasteners such as screws and screwdriver have been widely used for attachment of parts. The screwdriver will convey a torque when engage into the recess at the screw head to fasten and loosen the screw. Various forms of recesses have been developed. Conventional recesses are in slotted or minus shape, cross or Philips shape, Pozidriv shape, Torx shape, Hex shape, Robertson shape, Torq-set shape, spanner head shape etc.

Among these screws, the slotted or minus shape screw has a most simple structure and most commonly use in woodworking applications. However, the drawbacks of this head are the screw driving tool bit cannot be centered on the slot of the screw head and the slot is open ended at both ends which cause the tool bit to be easily disengaged from the recess in the screw head. This causes an inefficient workability.

The cross shaped screw is widely used everywhere and having the advantage of the tool bit to engage in the recess centered on the screw head. But when there is high resistance to penetration, the screw turns less than the tool bit, forcing the tool bit out of the recess void of the screw head. When this happens, the external edges of the bit begin to cut the inner corners of the recess in the screw head, thereby enlarging the center into a rounded pit causing screw failure as the screw could not be turned anymore and has to be replaced. Disengagement of the driving tool would cause the driving tool to slip out of the recess and sometimes scratches the surface of the work.

In one embodiment under Patent no: AT 113091 A (Cvetkovic Mirko), the recess is formed from arc_walls joining each other smoothly in ‘S’_formation, without interlocking sharp corners to effect a strong grip by the driving tool. The drive faces are curved and short, limiting the transfer of torque. Base walls have single inclination to bottom, whereas side walls are vertical making insertion of tool bit difficult.

In yet another embodiment under U.S. Pat. No. 7,111,531 (Suzuki Yasuo), the whole recess is confined within the circumference of the shank. This represents a fundamental difference in design to effect torque transfer. Principles of physics stipulate that torque transfer will be more effective when the engaging drive faces reach out more towards the head circumference. The drive faces located at shank circumference are too small to effect much torque transfer.

Other significant differences of the abovementioned prior art are apparent upon further comparison with the description of the present invention.

The present invention overcomes the drawbacks of the known fasteners and driving tools while maintaining its advantages.

It is an object of the present invention to provide a fastener and driving tool wherein the lengthened arms of the grooves of the driving recess in the fastener head is suited to good torque transmitting engagement by the driving tool.

Another object of the present invention is to provide the fastener with sharp interlocking corners for receiving and locking with the corresponding sharp interlocking edges of the driving tool bits to prevent the bits from slipping out of the recess even during high resistance to penetration of the fastener.

Yet another object of the present invention is to provide the fastener with higher strength structure that is not prone to failure during fixing by minimizing the recess void bounded by the threaded shank circumference and thus increasing metal connectivity of head to shank.

Additional objects, advantages and novel features of the invention shall be set forth in part in the description that follows and in part will become apparent to those skilled in the art upon examination of the following or may be learned by the practice of the invention. The objects and advantages may be realized and attained by means of the instrumentalities and in combinations particularly pointed out in the appended claims.

### SUMMARY OF THE INVENTION

In the present invention, an improved fastener comprises of a threaded shank; and a head connected to the threaded shank characterized in that the head having a driving tool engaging recess that is formed with a plurality of grooves comprising an inner portion confined within the circumference of the shank, formed by side walls characterized in part elliptical configurations, an outer portion formed with pairs of flat drive walls, concentric peripheral end arcs and sharp drive corners. Sharp interlocking corners separate inner portion from outer portion at approximately shank circumference position, and are formed by arc walls meeting with flat drive walls at obtuse angles. The whole recess is engageable with a driving tool having corresponding drive bits that snugly fit and firmly interlock with the grooves of the recess in the head and prevent the tool bits from slipping out of the recess of head during strong resistant to penetration.

Preferably the recess of the fastener is arranged in Y-shape on the top face of the head with the wider outer portion and the narrower inner portion of grooves symmetrically spaced at the central axis.

Preferably the side walls of inner portion of grooves are characteristically inclined at a preferably larger angle to the vertical axis than the angle of the inclined flat drive walls of the outer portion.

Preferably the base walls of inner and outer portion of grooves have a total depth less than the thickness of the screw head.

A driving tool for operating the fastener comprises of a shank, and a driving head having respective drive bits that engage in and substantially conform to the shape of the recess of the fastener. The driving head bits include an inner portion formed by side walls characterized in part elliptical configurations and outer portion formed by flat drive walls, with sharp interlocking edges separating inner portion from outer portion. The interlocking edges are formed by arc walls meeting with flat drive walls at angles of more than 180 degrees.

### BRIEF DESCRIPTION OF THE DRAWINGS

Other objects, features, and advantages of the invention will be apparent from the following description when read with reference to the accompanying drawings. In the drawings, wherein like reference numerals denote corresponding parts throughout the several views:

FIG. 1 is top view of the fastener of the present invention showing the configuration of the recess at top face of the fastener head.

FIGS. 2a, 2b, and 2c show cross sectional views of the section X-X, y-y, z-z as indicated in FIG. 1, showing the inclined faces of the base walls of the grooves of the recess and the different inclinations of the side walls.

FIG. 3 depicts a side view of the driving tool for operating the fastener of the present invention.

FIG. 4 illustrates a bottom view of the driving tool showing the drive head with the bits having corresponding shape of the recess for the fastener.

FIG. 5 illustrates a variation of FIG. 1 wherein the drive walls are aligned parallel to each other.

FIG. 6 illustrates a variation of FIG. 1 wherein the drive walls skew outwards to each other.

FIG. 7 illustrates a variation of FIG. 1 wherein the inner portion of the grooves is formed of single arc walls.

### DETAILED DESCRIPTION OF THE PREFERRED EMBODIMENTS

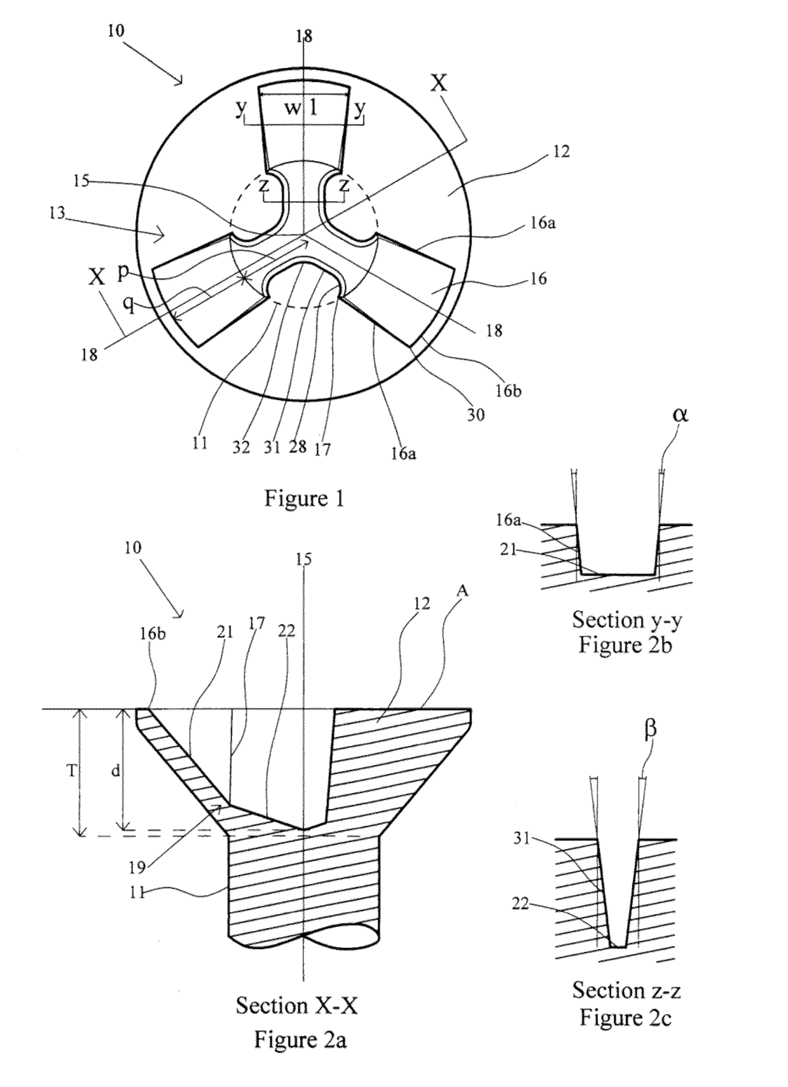

Referring now to the drawings, and particularly to FIG. 1, and FIGS. 2a, 2b and 2c thereof, there is shown a fastener (10) having a threaded shank (11) and a head (12) connected thereon. The head (12) is substantially circular and provided with a driving tool engaging recess (13) formed in the top face of the fastener (10) where the recess (13) has a tapered cross section for easy insertion of the driving tool (14). The recess (13) at the center of the head (12) is formed by a plurality of grooves (16) extending radially outwards from the central axis (15), spaced symmetrically there around and comprises an inner portion (p) located approximately within circumference of shank (11), formed by inclined side walls (28, 31, 32) characterized in arc (28)—line (31)—arc (32)—line (31)—arc (28) part elliptical configurations disposed convexly and symmetrically to central axis (15) and bisector lines (18) and an outer portion (q) formed with pairs of inclined flat drive walls (16a), concentric peripheral arcs (16b) near circumference of head (12) and sharp drive corners (30). The sharp interlocking corners (17) separating inner portion (p) from outer portion (q) approximately at shank circumference (11) are formed by inclined arc walls (28) meeting with inclined flat drive walls (16a) preferably of a different inclination, at obtuse angles in the recess (13). The whole recess (13) is engageable with a driving tool (14) having corresponding drive bits (25) to fit snugly in recess (13) in head (12) for firm interlocking action and to prevent the drive bits (25) from slipping out of recess (13) of head (12) during strong resistant to penetration. The firm interlocking action between drive bits (25) and recess (13) is primarily achieved by the configurations of the sharp interlocking corners (17) locking with the sharp interlocking edges (29) of the driving tool (14).

The side walls (28, 31, 32) of inner portion (p) of grooves (16) are inclined at a preferably larger angle (β) to the vertical axis than the angle (α) of the inclined flat drive walls (16a) of the outer portion (q) for better grip between grooves (16) and drive bits (25). The inclined flat side walls (31) of inner portion (p) of grooves (16) are in parallel alignment and equidistant from bisector lines (18) of grooves (16).

Preferably the fastener (10) of the present invention is made of metal. The head (12) of the fastener (10) could be formed in pan head, button or dome head, round head, truss head, flat head or countersunk, oval or raised head, bugle head, cheese head, fillister head and the like.

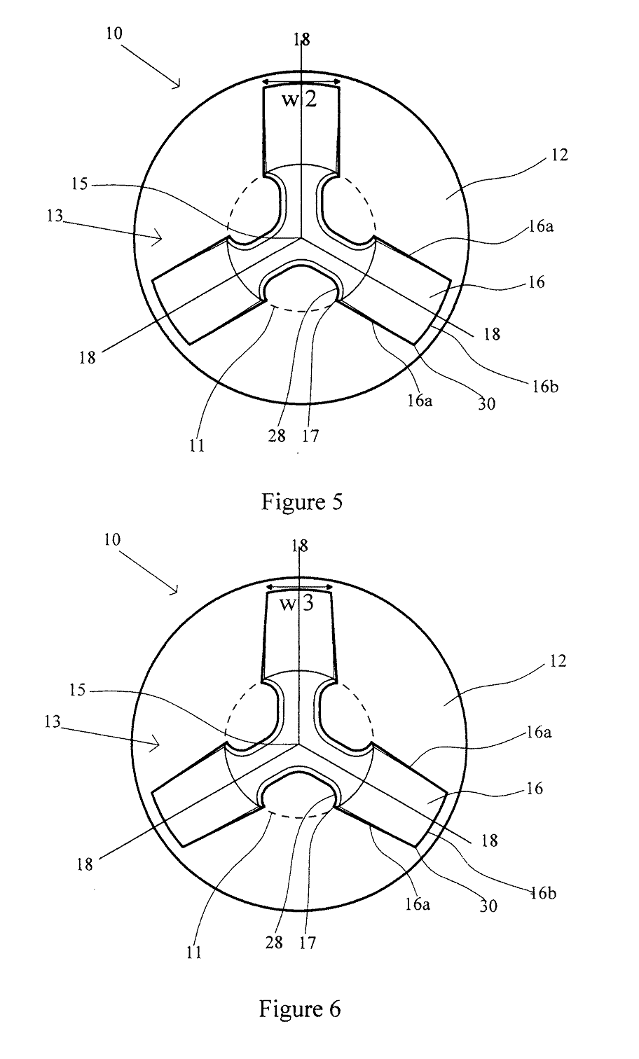

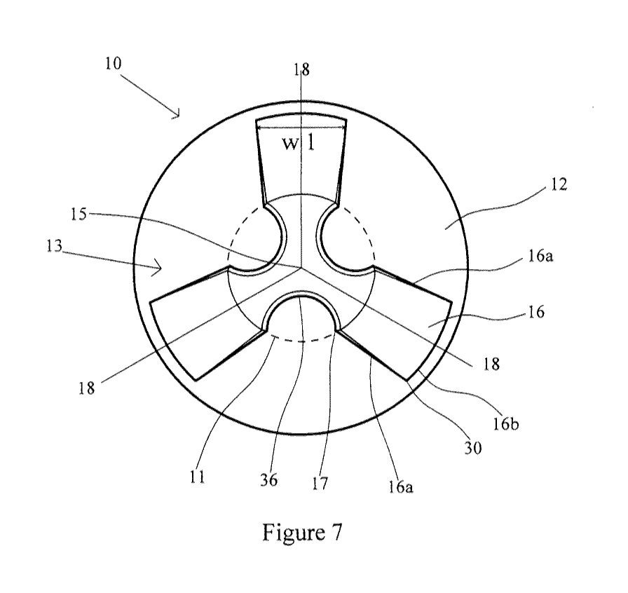

In a preferred embodiment of the present invention, the fastener (10) includes three grooves (16) symmetrically arranged in Y-shape on the top face of the screw head (12) as shown in FIG. 1. A person skilled in the art may configure the shape of the proposed recess (13) as shown in FIG. 1 into other forms as shown in FIGS. 5, 6 and 7 and further generic variations of FIG. 7 and the like. The pairs of inclined flat drive walls (16a) of grooves (16) are characteristically aligned parallel (W2), as shown in FIG. 5, and equidistant from bisector lines (18) of grooves (16). FIG. 6 shows the pairs of inclined flat drive walls (16a) of grooves (16) characteristically skew outwards (W3) symmetrically along bisector lines (18) of grooves (16). FIG. 7 shows the inner portion (p) of grooves (16) formed by inclined single arc side walls (36), disposed convexly to central axis (15). The grooves are symmetrically spaced between bisectors (18) of grooves (16) and characterized in that inclined arc walls (36) meet inclined flat drive walls (16a) of a different inclination, approximately at circumference of shank (11) to form sharp interlocking corners (17) at obtuse angles in recess (13). The wider outer portion (q) of grooves (16) symmetrically spaced at the central axis (15) provide for more robust turning of the fastener (10) by the correspondingly thicker drive bits (25). The narrower inner portion (p) of grooves (16) provide for more metal connectivity between head (12) and shank (11) as compared to the Phillips Head. The lengthened arms of the groove (16) result in more torque transfers from the driving tool (14) to the recess (13) in the head (12).

The grooves (16) have base walls (19) with an inner portion (p) (22) and an outer portion (q) (21) that fit snugly with the inclined drive faces (26a, 26b) of the drive bits (25) to provide a strong torque to the fastener (10) and extend in radial direction from a central axis (15) and symmetrically spaced at bisector lines (18) of grooves (16). The base walls (19) of grooves (16) have a total depth (d) less than the thickness (T) of the screw head (12). The outer portion inclined faces (21) incline less to the vertical axis than the inner portion inclined faces (22). The outer portion inclined faces (21) of base walls (19) of grooves (16) also have a depth deeper than half depth (d) of grooves (16) of recess (13).

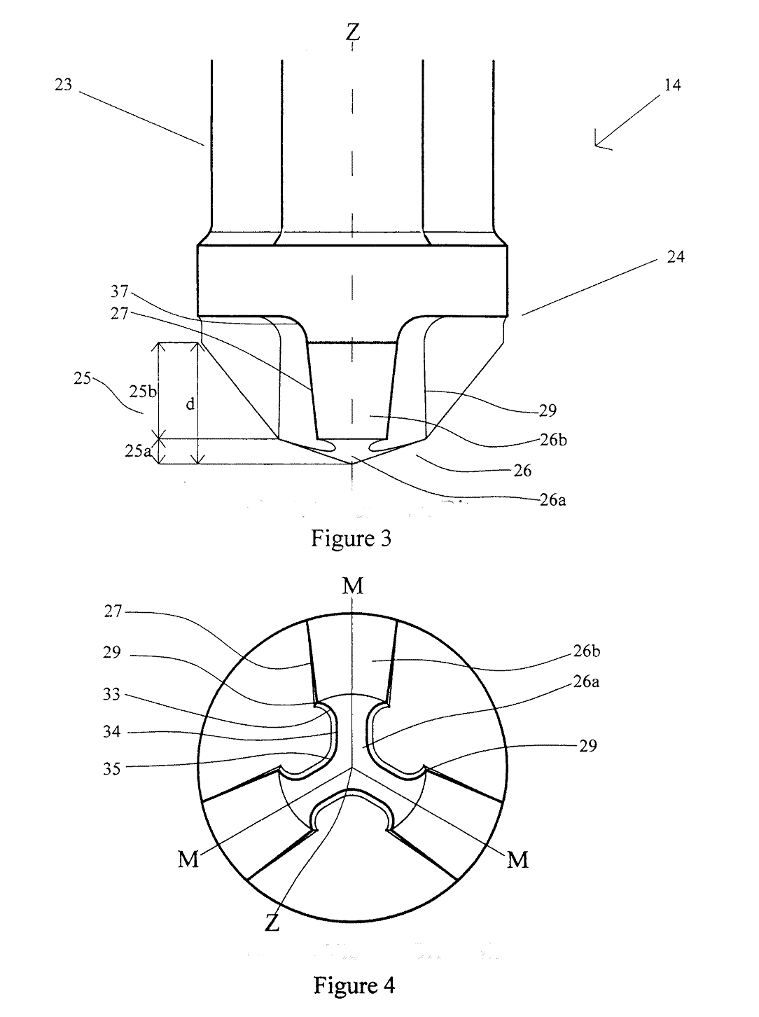

The base wall (19) at the central axis (15) being the deepest portion with respect to the top face of the screw head (12), centered the driving tool (14) on the fastener head (12). Within each of the groove (16) is receivable a radially outwardly projecting correspondingly shaped drive bit (25) of the driving tool (14) as shown in FIG. 3 and FIG. 4.

The driving tool (14) as shown in FIG. 3 is used to apply and remove the fastener (10). The driving tool (14) includes a shank (23) and a driving head (24) with respective drive bits (25) that engage in and substantially conform to the shape of the recess (13) of the fastener (10). As an option, the shank (23) is preferably formed in hexagonal section shape for easy fitting into a socket of the screwdriver shank to rotationally drive the driving tool (14) about its longitudinal central axis. The shank (23) slot fits into a socket holder (not shown) of the screwdriver shank having an end slot for receiving different sizes of drive heads (24). The drive head (24) has drive bits (25) comprising of an inner portion of bits (25a) formed by inclined side walls (33, 34, 35) having part elliptical configurations disposed convexly and symmetrically to central axis (Z) and bisector lines (M) and an outer portion of bits (25b) formed by inclined flat drive walls (27) which engage with the corresponding inner and outer portion of the grooves (16) of the fastener recess (13) for turning the fastener (10). In a preferred embodiment of the present invention, three drive bits (25) are arranged symmetrically at central axis (Z) to each other with angles of 120 degrees between bisector lines (M). The number of drive bits (25) of the driving tool (14) should correspond with the number of grooves (16) of the recess (13) of the fastener (10). The inner part inclined face (22) of the groove (16) ended in V tip enabling the drive bits (25) to be centered into the recess (13) of the head (12) thereby increasing the fastening and loosening efficiency of the fastener (10).

The drive bits (25) have outer portion faces (26b) inclining less to the vertical axis than the inner portion faces (26a) and snug fit respectively with the base wall (19) at the inner portion inclined faces (22) and outer portion inclined faces (21) of the recess (13) respectively, wherein inner portion inclined side walls (33, 34, 35) engages with inclined side walls (28, 31, 32) of inner portion (p) of grooves (16), while the inclined flat drive walls (27) of the driving tool (14) engage the inclined flat drive walls (16a) of the recess (13), to convey an effective large torque to the fastener (10) when the driving tool (14) engages into the recess (13) with just a small rotational force. The inclined flat drive walls (27) meet with inclined arc walls (33) of a different inclination at angles more than 180 degrees to form sharp interlocking edges (29) which conform to the shape of the sharp interlocking corners (17) of the fastener (10) for locking during the turning of the fastener (10) and thus preventing the drive bits (25) from slipping out of the recess (13) even during high resistance to penetration of the fastener (10). The outer portion bits (25b) of drive bits (25) are characteristically deeper than half depth (d) of the bits (25).

The base of the cylindrical drive head (24) meets the outer portion of the inclined drive walls (27) and the inner portion side walls (33, 34, 35) of the drive bits (25) at arc junctions (37).

The arms of the drive bits (25) are maximized to the edge of the fastener head (12), thereby increasing torque transfer to the fastener (10). The workability increases as the drive bits (25) easily enter into the desired grooves (16) of the fastener (10). The fastener (10) also attains higher robust and strength structure as the recess void bounded by the shank (11) circumference is minimized thereby increasing metal connectivity of head (12) to shank (11) preventing the head (12) of the fastener (10) being twisted off during high torque application. In the event when the driving tool (14) slips out of the recess (13) during the operation, it will not create a large pit in the center that will cause fastener failure.

As will be readily apparent to those skilled in the art, the present invention may easily be produced in other specific forms without departing from its essential characteristics. The present embodiments is, therefore, to be considered as merely illustrative and not restrictive, the scope of the invention being indicated by the claims rather than the foregoing description, and all changes which come within therefore intended to be embraced therein.

1-20. (canceled)

21. A fastener (10) with a threaded shank (11) connected to a head (12) having a tool engaging recess (13) formed by a plurality of grooves (16), said grooves (16) comprising:
an inner portion (p) of grooves (16) located approximately within circumference of shank (11), formed by inclined side walls (28, 31, 32) characterized in arc (28)—line (31)—arc (32)—line (31)—arc (28) part elliptical configurations disposed convexly and symmetrically to central axis (15) and bisector lines (18);
an outer portion (q) of grooves (16) formed with pairs of inclined flat drive walls (16a), concentric peripheral arcs (16b) near circumference of head (12) and sharp drive corner (30);
sharp interlocking corners (17) separating inner portion (p) from outer portion (q) approximately at shank circumference (11), formed by inclined arc walls (28) meeting with inclined flat drive walls (16a) preferably of a different inclination, at obtuse angles in recess (13); and
base walls (19) with an inner portion (p) (22) and an outer portion (q) (21);
wherein the grooves extend in radial direction from a central axis (15) and symmetrically spaced at bisector lines (18) of grooves (16) on top of head (12).

22. A fastener (10) as claimed in claim 21, wherein side walls (28, 31, 32) of inner portion (p) of grooves (16) are characteristically inclined at a preferably larger angle (β) to the vertical axis than the angle (α) of the inclined flat drive walls (16a) of the outer portion (q).

23. A fastener (10) as claimed in claim 22, wherein inclined flat side walls (31) of inner portion (p) of grooves (16) are in parallel alignment and equidistant from bisector lines (18) of grooves (16).

24. A fastener (10) as claimed in claim 21, wherein base walls (19) of grooves (16) have a depth (d) less than the thickness (T) of the screw head (12).

25. A fastener (10) as claimed in claim 24, wherein base walls (19) of grooves (16) are characterized by outer portion inclined faces (21) inclining less to the vertical axis than the inner portion inclined faces (22).

26. A fastener (10) as claimed in claim 25, wherein the outer portion inclined faces (21) of base walls (19) of grooves (16) are characteristically having a depth deeper than half depth (d) of grooves (16) of recess (13).

27. A fastener (10) as claimed in claim 21, wherein the pairs of inclined flat drive walls (16a) of grooves (16) are characteristically skew inwards (W1), symmetrically along bisector lines (18) of grooves (16).

28. A fastener (10) as claimed in claim 21, wherein the pairs of inclined flat drive walls (16a) of grooves (16) are characteristically aligned parallel (W2) (FIG. 5) and equidistant from bisector lines (18) of grooves (16).

29. A fastener (10) as claimed in claim 21, wherein the pairs of inclined flat drive walls (16a) of grooves (16) are characteristically skew outwards (W3) (FIG. 6) symmetrically along bisector lines (18) of grooves (16).

30. A fastener (10) as claimed in claim 21, wherein inner portion (p) of grooves (16), is formed by inclined single arc side walls (36) disposed convexly to central axis (15), symmetrically spaced between bisectors (18) of grooves (16) (FIG. 7), characterized in that inclined arc walls (36) meet inclined flat drive walls (16a) of a different inclination, approximately at circumference of shank (11) to form sharp interlocking corners (17) at obtuse angles in recess (13).

31. A fastener (10) as claimed in claim 21, wherein the grooves (16) as described can be used for flat (countersunk) head (A) (FIG. 2a), pan head (B) (FIG. 8), button head (C) (FIG. 9), round head (D) (FIG. 10), and oval head (E) (FIG. 11).

32. A driving tool (14) with shank (23) and drive head (24) having drive bits (25) for turning said fastener (10) as claimed in claim 1, wherein said drive bits (25) comprise:
an inner portion of bits (25a) formed by inclined side walls (33, 34, 35) having part elliptical configurations disposed convexly and symmetrically to central axis (Z) and bisector lines (M);
an outer portion of bits (25b) formed by inclined flat drive walls (27);
sharp interlocking edges (29) separate inner portion of bits (25a) from outer portion of bits (25b), formed by inclined arc walls (33) meeting with inclined flat drive walls (27) of a different inclination at angles more than 180 degrees; and
base of cylindrical drive head (24);
wherein inner portion inclined side walls (33, 34, 35) engages with inclined side walls (28, 31, 32) of inner portion (p) of grooves (16), outer portion inclined drive walls (27) engages with inclined flat drive walls (16a) of outer portion (q) of grooves (16) and sharp interlocking edges (29) engages sharp interlocking corners (17) approximately at shank circumference (11).

33. A driving tool (14) as claimed in claim 32, wherein the outer portion bits (25b) of drive bits (25) are characteristically deeper than half depth (d) of the bits (25).

34. A driving tool (14) as claimed in claim 32, wherein the outer portion bits (25b) are characterized by faces (26b) inclining less to the vertical axis than the inner portion faces (26a) and snug fit respectively with outer portion inclined faces (21) and inner portion inclined faces (22) of base walls (19) of grooves (16).

35. A driving tool (14) as claimed in claim 32, wherein inner portion of drive bits (25a) are formed by inclined side walls (33, 34, 35) characterized in arc (33)—line (34)—arc (35)—line (34)—arc (33) part elliptical configurations disposed convexly to central axis (Z), symmetrically between bisectors (M) of bits (25) to engage snugly with corresponding inclined side walls (28, 31, 32) of inner portion of fastener recess (13).

36. A driving tool (14) as claimed in claim 32, wherein base of cylindrical drive head (24) meets outer portion inclined drive walls (27) and inner portion side walls (33, 34, 35) of drive bits (25) at arc junctions (37).

37. A driving tool (14) as claimed in claim 32, wherein shank (23) of driving tool (14) slot fits into a socket holder of a fastener driver shank.

38. A driving tool (14) as claimed in claim 32, wherein bits (25) can fit into recess (13) of fastener head (12) for flat (countersunk) head (A) (FIG. 2a), pan head (B) (FIG. 8), button head (C) (FIG. 9), round head (D) (FIG. 10) and oval head (E) (FIG. 11).
